(19) United States
(12) Patent Application Publication
(10) Pub. No.: US 2019/0019158 A1
(43) Pub. Date: Jan. 17, 2019

(54) QUALITY EVALUATION OF RECOMMENDATION SERVICE

(71) Applicant: Linkedln Corporation, Sunnyvale, CA (US)

(72) Inventors: Hai Jian Guan, San Mateo, CA (US); Carson Moore, San Francisco, CA (US); Luwei Zhang, San Francisco, CA (US); Daniel Antzelevitch, San Francisco, CA (US)

(21) Appl. No.: 15/649,046

(22) Filed: Jul. 13, 2017

(51) Int. Cl. G06Q 10/10; G06N 99/00

(52) U.S. Cl. CPC G06Q 10/1053; G06N 99/005

(57) ABSTRACT

In some embodiments, the disclosed subject matter involves a system and method relating to evaluating the quality of recommendations provided to a member of a recommendation service. Techniques and embodiments described herein may be applied to various recommendation services/engines. Middleware may be used to receive a member ID from a user and forward the member ID to a recommendation engine without the user having to log on as the member to access recommendations. Results of the recommendation engine may be received by the middleware and forwarded to the user for the selected member to be displayed proximate to the member profile. The user may annotate the recommendations with a relevancy rating to evaluate the quality of the recommendation engine and provide input to retrain recommendation models of the engine. Other embodiments are described and claimed.

### TECHNICAL FIELD

An embodiment of the present subject matter relates generally to recommendation services, and more specifically, but without limitation, to measuring the quality of the recommendations provided to a user.

### BACKGROUND

Various mechanisms exist for services that match members to members, or members to elements/items or things, such as: recommending movies; news articles; songs; advertisements; dating services; match students to universities, such as for determining offers for the next entering class; and services that provide other matching and recommendation services, such as match members to jobs. For instance in a job searching and recommendation service, the service may provide for job searching; and match jobs to members, such as for recruiting. Members of a service may have different level of seniority, sign-in frequency, profile richness, browsing patterns, etc. Intuitively, it may be expected that members in different segments may have different intentions, and that their experience with the service should be tailored, and recommendations made accordingly. In existing systems, the member population of those using a service may be defined into concrete segments. For instance, a job search service may define segments such as: executive, active job-seekers, talent seekers, etc. Each distinct segment is typically served by a different service model. In the long run, as services evolve, the architecture and code for servicing these concrete segments may become difficult to understand and maintain, especially when considering that the defined segments may intersect in ways not able to be leveraged by legacy services.

Measuring the quality of the recommendations may be difficult. Short of members actively complaining that the recommendations they receive are irrelevant, it may be difficult to assess whether the recommendation models are performing adequately, without manually looking at the recommendation and comparing to a member's profile.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a system block diagram of a job recommendation system, according to an embodiment;

FIG. 2 is a system block diagram of a quality evaluation system for job recommendation, according to an embodiment;

FIG. 3 is an illustration of a sample graphical user interface for quality evaluation, according to an embodiment;

FIG. 4 is an illustration of a sample graphical user interface for quality evaluation, according to an embodiment;

FIG. 5 is a flow diagram for a method of quality evaluation for job recommendation, according to an embodiment;

FIG. 6 is a block diagram illustrating an example mobile device, upon Which one or more embodiments may be implemented; and

FIG. 7 is a block diagram illustrating an example of a machine upon which one or more embodiments may be implemented.

### DETAILED DESCRIPTION

in the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method relating to measuring the quality of recommendations provided to a member of a recommendation service. It should be understood the techniques and embodiments described herein may be applied to various recommendation services/engines. However, to simplify the discussion, the quality measurements are described using an example job recommendation service. As compared to a music or book recommendation engine, for instance, members may be more concerned about being provided high quality recommendations for a relevant job, than a relevant book to read. Thus, providing relevant job recommendations is important to the success of the job recommendation service, and member satisfaction with the service.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

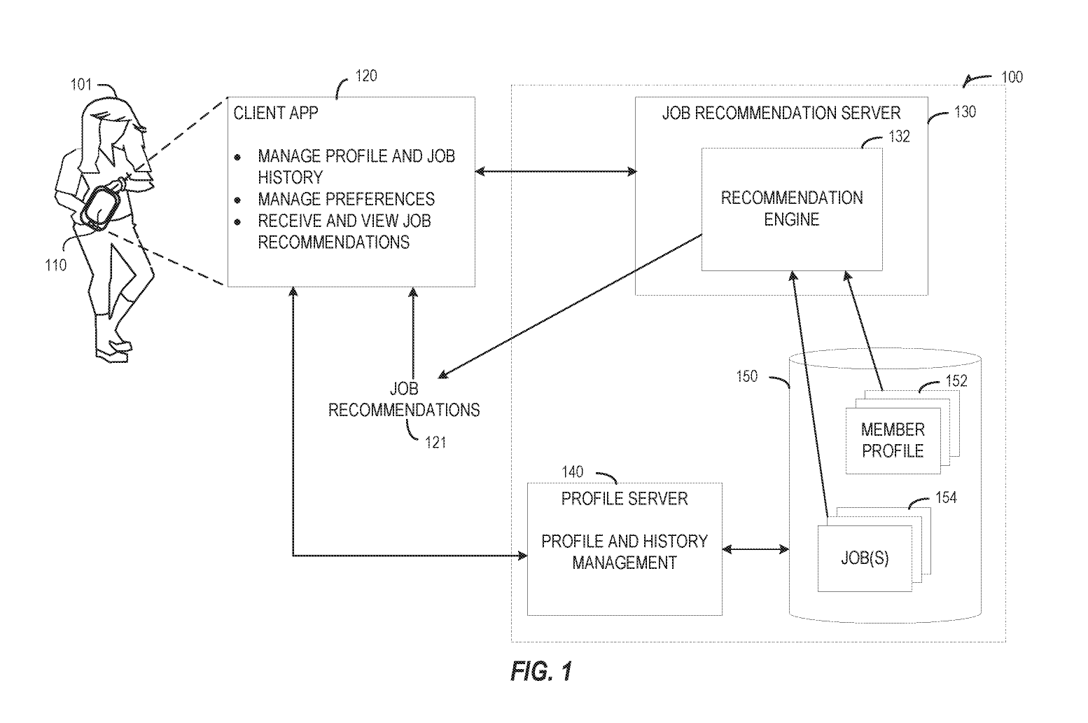

FIG. 1 is as a system block diagram of a job recommendation system, according to an embodiment. In an embodiment, a user 101 accesses a client application 120 on a mobile device 110. In another example, the user 101 uses a desktop computer, laptop computer, tablet, or other computing device to access a client application 120 for managing use of recommendation service 100. In an embodiment, a recommendation service 100 is available via a network such as the public Internet (not shown). For purposes of explanation, a job recommendation service is described herein, However, it will be understood that embodiments may be used for other types of recommendation services.

User 101 may manage her user profile information, such as job history and skills via a client application 120. Preferences for matching, such as jobs or locations preferred, or periodicity of receiving recommendations, etc., may be managed via the client application 120. The client application 120 communicates with a recommendation engine 132 residing on, or coupled to, a job recommendation server 130. The recommendation engine 132 communicates to a database 150 to access member profiles 152 and jobs 154. It will be understood that for other types of recommendations, the items to be matched with the user would replace the jobs 154 portion of the database 150. When user 101 creates or updates her profile, a profile manager in a profile server 140 may enter or update the information in the member profiles 152 in the database 150. The recommendation engine 132 retrieves a member profile 152 and job information 154 to identify jobs matching a job search or ad hoc recommendations for jobs that may be of interest to user 101. Job recommendations 121 may be sent to the user 101 by the recommendation engine 132. It will be understood that the job recommendation server may include one or more processes for performing recommendation services and management of profiles. The processes may be implemented in hardware circuitry, software modules or logic, firmware or any combination. The modules/logic may be performed serially, or in parallel by one or more processors which may be physically or wirelessly coupled. Further, a single database may be used to store the member profiles 152, jobs 154 and recent job recommendations 121. In another embodiment, more than one physical database is used to store the information used by the recommendation engine 132. In an embodiment, the recommendation engine 132 and profile server 140 are coupled as one module with multiple functions, or in another embodiment, are separate modules or logic on the job recommendation server 130.

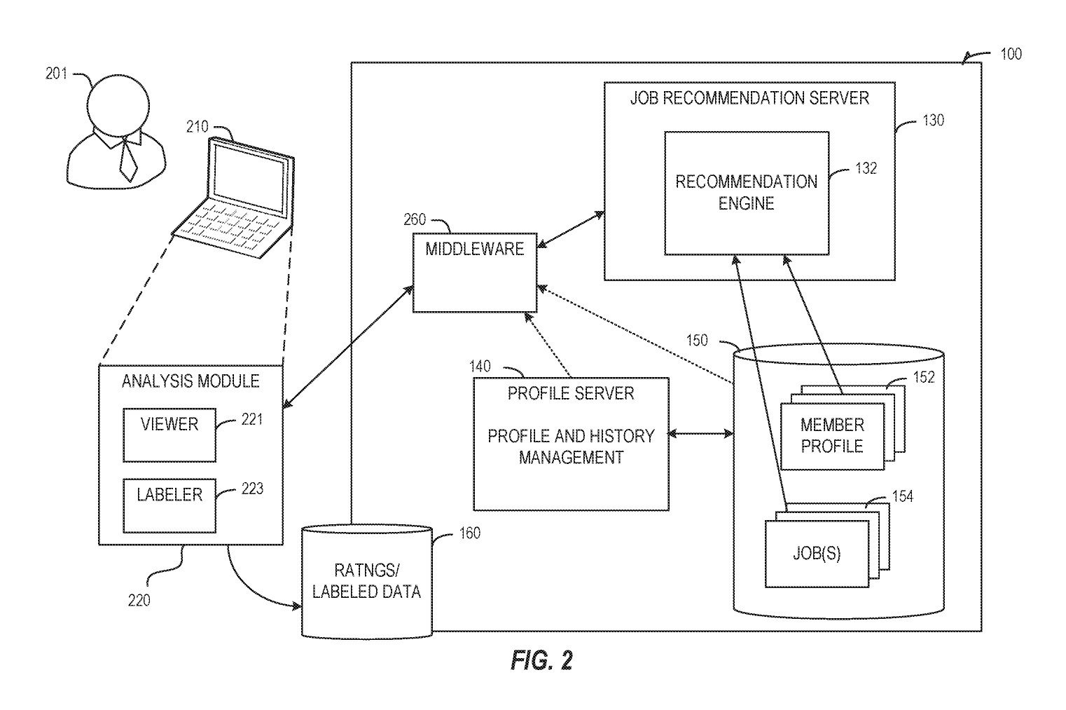

FIG. 2 is a system block diagram of a quality evaluation system for job recommendation, according to an embodiment. In an embodiment, the recommendation engine 132 may use a variety of trained algorithms or machine learning models to provide matches or recommendations to user 101. It is important to the provider of the recommendation service to be able to provide high quality and relevant recommendations. However, identifying and evaluating the quality of the recommendations can be a cumbersome process. For example, a system may require an analyst/programmer 201 to login to the recommendation system as a specific user in order to receive recommendations as they would be provided to the user. Then analyst 201 may need to save the information; log back in as a privileged user; and analyze the data. In order to fully evaluate the recommendations provided, the analyst 201 may need to log in and out of one or more accounts several times to access the same results as would be provided to the user. Not only is this a cumbersome process but it also undesirable (or it may not even be possible) to have an analyst 201 login to the system as a specific user.

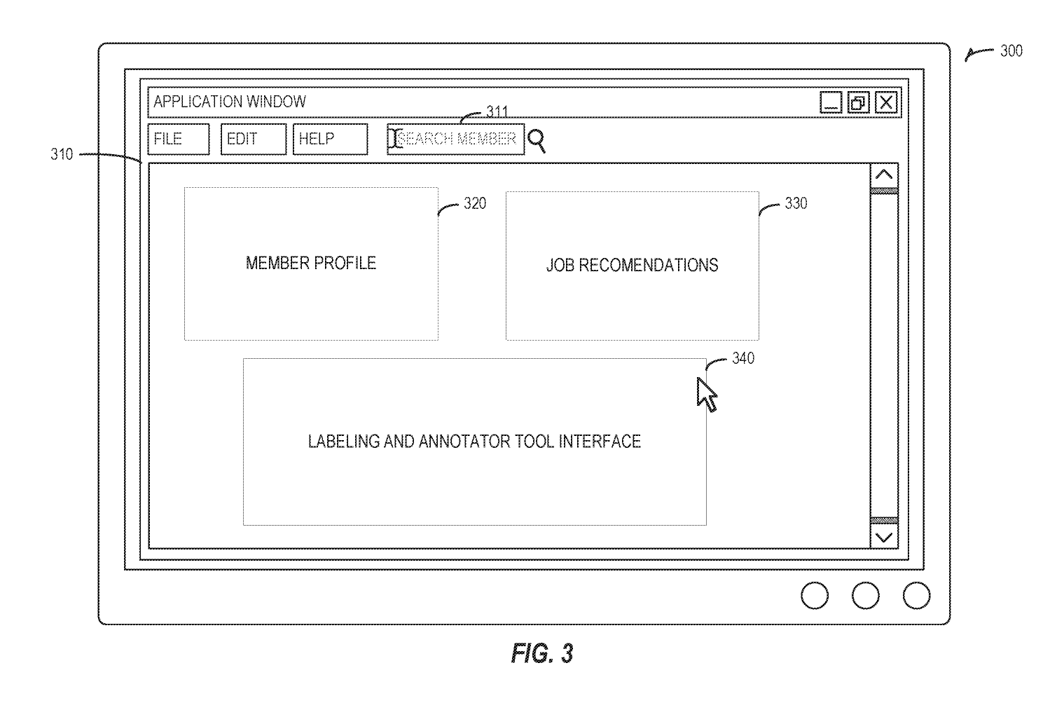

In an embodiment, analyst 201 utilizes an analysis module 220 on computing or display device 210 to perform a quicker and more accurate evaluation of results of the recommendation engine 132. In an embodiment, the analysis module 220 comprises viewer logic 221 and labeler logic 223. In an embodiment, the analysis module may execute on a server, and provide recommendation results, a data input area, and display rendering this and other information, from the server to the computing device 210, such as in a Web browser. In an example embodiment, the analysis module 220 may reside on a server coupled to, or communicatively coupled to the recommendation service 100. Referring now to FIG. 3, there is shown an illustration of a sample graphical user interface (GUI) 300 for quality evaluation, according to an embodiment. The viewer logic 221 may be coupled to GUI 300 to allow analyst 201 access, and to view user profiles 320, recommendations 330 and labeling or annotation logic 340. A single application window 310 may enable the analyst to evaluate the recommendations without cumbersome and repetitive log in and log out actions. For instance, in an embodiment, analyst 201 may search for a member id in search box 311. It will be understood that various methods and criteria may be used to search for members. A user name, title, industry, geographic location, etc., may be used in the search. The member search may return one member, a list of members, a list of top n number of matching members, or return null (e.g., no matching member found).

Once the analyst 201 selects a member, the associated member profile may be rendered in the member profile portion 320 of the application window 310. In an embodiment, analysts 201 may have permission or access levels for members or groups of members. Referring again to FIG. 2, middleware 260 may provide access control to member profiles 152. In an embodiment, middleware 260 may have access to the member profile and job information in database 150. In an embodiment, all analysts for the recommendation service provider may have unrestricted access to all members. However, it may be advantageous to segment the member population by industry, skills, job title, etc., and allow access of the segment to only a subset of analysts. For instance, this allows analysts to become expert in a more narrow field rather than being required to evaluate relevance in all fields.

Once middleware 260 has determined that analyst 201 is permitted to view the selected member profile, the profile may be rendered in the application window 310. Referring again to FIG. 3, once the member profile is selected and displayed 320, middleware 260 may send a request to the job recommendation engine 132 to receive job recommendations 121 for the member. In an embodiment, the recommendation engine 132 is configured to return job recommendations when receiving a member identifier. The recommendation engine 132 may access the member profile 152 and set of available jobs 154 in database 150. In an embodiment, the recommendation engine 132 provides privacy and access control. In another embodiment, an access control module (not shown) coupled to the recommendation service 100 acts as a gatekeeper, e.g., only allowing authorized processes access to the recommendation engine 132. Once the analyst has been authenticated as a permitted user, job recommendations 121 may be rendered in a job recommendation portion 330 of the application window 310.

Once the member profile 320 and job recommendations 330 are viewable by the analyst, evaluation of the relevance of the job recommendations may be performed. In an embodiment, analysts evaluate members in similar job categories and may become practiced in evaluating relevance of recommended jobs for a subset of categories. In other embodiments, analysts may evaluate broader categories of members. A member profile may include information about a member's job title, experience level, interests and skills. In an example, a member's job category, experience level and last few job titles may be displayed in member profile portion 320. The displayed job recommendations 330 may include a job title and required experience. The number of recommendations displayed may be driven by display size and/or resolution, number of recommendations returned. The top in job recommendations may be displayed or be capable of viewing via a scroll bar. The analyst may take a quick look at the member profile information and job recommendation information and make a quick value judgment as to the relevance of individual recommendations.

In an embodiment, the analyst 201 may check a box adjacent to a recommendation in portion 330 (not shown) to indicate relevance. In an example of 10 recommendations provided, it will be understood that if all 10 jobs are evaluated as relevant, then the job recommendation service may be deemed as successful. However, in the example, if only two or three jobs are marked as relevant, the recommendation engine may be deemed as poor or failing. In an embodiment, a relevance check box is present in the window portion adjacent to or along with the job recommendation 330. In another embodiment, the job recommendation portion 330 may be static or scrollable, but remain read-only. Individual job recommendations may be identified with an index or other unique identifier. In this example, a relevance checkbox may be provided in a labeling and annotation window interface 340. The job recommendation identifier associated with a job recommendation in 330 may be displayed in 340 along with one or more user editable fields or boxes. In an embodiment, an analyst may mark a job recommendation as relevant, based on criteria viewed in the member profile 320. In an embodiment, the analyst may further be able to enter free form text, or structured text from a pull down list of items to further qualify issues with the recommendation.

In an embodiment, for each individual job recommendation, the analyst may enter a rating, for instance on a scale of 1-10, to judge the relevance of the recommendation to the member profile. The criteria for rating may be subjective based on the analyst's familiarity with the industry (e.g., terms for skills, etc.) or be based on objective criteria as pre-defined by the provider. Comments may also be associated with the rating. In an example, the analyst may comment that a term is frequently misspelled and mistaken for another term, so additional context should be evaluated. Another comment might identify similar terms used in different industries that may cause mischaracterization of a skill or job title.

The ratings data entered in GUI 340 may be aggregated, correlated and then summarized and rendered in a display for easy visualization. Analysts may monitor the relevance evaluation trends over time to easily see how quality improved or declined. Adjustments to the recommendation algorithms may be made by an algorithm team, based on the trends, ratings, annotations and general feedback from analysts during the evaluation process.

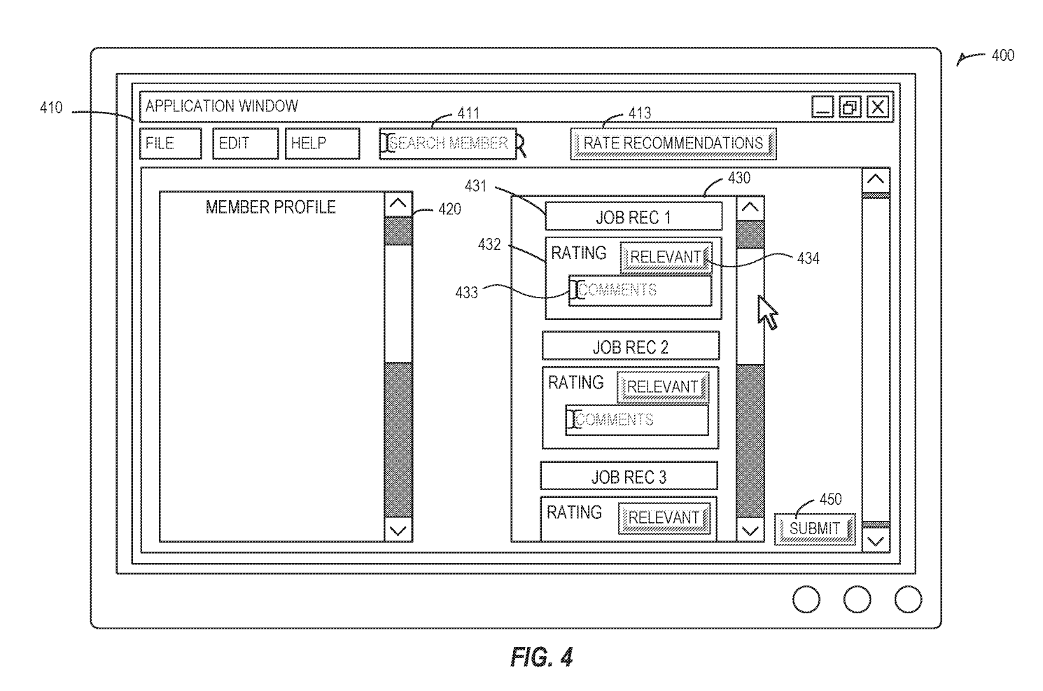

FIG. 4 is an illustration of a sample graphical user interface (GUI) 400 for quality evaluation, according to an embodiment. In this embodiment, application window 410 is a browser interface, such as the Chrome™ browser available from Alphabet Inc. A member profile 420 is viewed in a window or portion of the GUI display. In an embodiment, the user/analyst may search for a specific member using search box 411. In an example, the analyst may see the member profile as it would appear to the public, e.g., non-connected users. In an example, the analyst may be whitelisted and have full viewing access to all, or a subset, of member profiles. Once the desired profile is displayed, the analyst may invoke a plug-in by selecting the rate recommendations button 413. In an embodiment, selection of the plug-in brings up an annotation and ratings window 430 in a portion of the display. The plug-in may communicate with the middleware, as discussed above, and in the job recommendation example, receive a list of job recommendation from the recommendation engine, based on the member profile being viewed. The ratings window 430 may include a scrollable list of the resulting job recommendations. A first job recommendation 431 may be displayed with a rating box 432 portion below or adjacent to the listed job. The rating box may have a relevance button 434. As shown in the illustration, the relevance box is a button, e.g., a binary selection of relevant or non-relevant may be enabled. It will be understood that the relevance box may be in the form of a Y/N selection a pull down binary selection area, or a numeric or text box allowing a rating scale to be entered. Other methods for entering a relevance rating may be used.

A comment box 433 may be available to further annotate the job recommendation. For instance, in an example, the comment box 433 may allow free form text of n characters. For instance, if a job is identified as low relevance because it is in the wrong industry compared to the member's experience, the analyst may enter a phrase such as “wrong industry.” In a case where the job has low relevance due to a seniority issue, e.g., the job requires 10-15 years' experience and the member has been working only three years, then the analyst may enter a phrase such as “member too junior,” “not enough experience,” or similar. The ratings and comments may be used to help an algorithm team to improve the recommendation engine. In an example, an analyst or team of analysts, may be dedicated to evaluating the recommendations for a specific category. Over time, the analysts may identify specific keywords to identify commonly seen issues. In an embodiment, the comment box allows only pre-defined keywords or phrases such as in a pull down selection area, Using a pre-defined set of issue keywords may allow for more structured analysis of the data and may provide opportunities for automatic re-training and improvement of the models that drive the recommendation engine.

Once the analyst has entered all of the ratings and optional comments, submission of the data may initiated with the Submit button 450. In an embodiment, when this button is selected, the data may be sent to an evaluation database for storage. In an embodiment, information that may be stored for each job recommendation may include: a user identifier (user ID) for the analyst; a member profile identifier (Member ID); a model identifier (model ID), returned by the middleware, to identify which recommendation model was used to provide the recommendations; a job recommendation identifier (job ID); and the relevance rating, e.g., yes/no or scaled rating.

In an embodiment, the Representational State Transfer (REST) API architecture may be used for transferring data to and from the GUI. In recent years, Web APIs following the REST architectural style, also known as RESTful APIs, have been becoming more popular because of their simplicity. REST is a set of principles including stateless communication and a uniform interface. Restful APIs revolve around resources, are addressable via URIs, and provide access to resources to a broad range of front-end consumers via simple HTTP verbs such as GET, PUT, POST, etc. For illustrative purposes, embodiments described herein use the REST architecture. It will be understood that the methods, algorithms and systems as described may be generalized and applied to other APIs with slight adaptation.

In an embodiment, the GUI issues REST calls to the middleware (260). The middleware accepts REST calls from the GUI and issues REST calls to an API associated with the recommendation engine (132) on the job recommendation server. A plug-in associated with the browser application 410 may use REST in the sense that the middleware requires it.

In an embodiment, a standalone program or process may be used as a self-contained GUI for displaying member profiles and job recommendation rating. However, it may be advantageous to leverage existing browser and GUI capabilities with a browser plug-in that is configured to communicate with middleware logic, as described above.

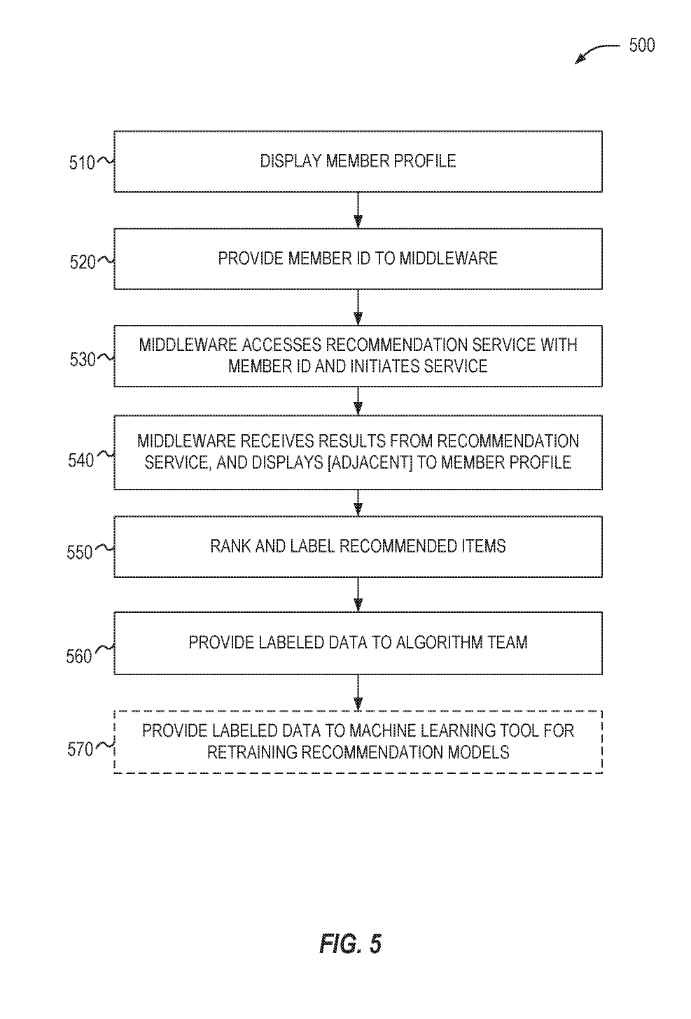

FIG. 5 is a flow diagram for a method 500 of quality evaluation for job recommendation, according to an embodiment. It will be understood that embodiments as described herein may be implemented for use with a recommendation engine with matching and recommendations for items other than jobs. In an embodiment, a member profile is displayed to an analyst in block 510. In an embodiment, the analyst may select a member profile as if a member of the general public, or as an authorized connection would see the profile. Once the analyst has selected a member for which to judge and evaluate recommendation relevance, the member identifier may be sent to middleware logic to retrieve an unrestricted copy, or access to the profile, in block 520. As discussed above, the access level for the analyst may be authenticated at a variety of checkpoints in the process. For instance, an analyst's access may be associated with a login identifier. In another example, an analyst may be required to enter additional credentials at the time the member profile is requested from the middleware logic. In an embodiment, access to the member profile may be direct from the GUI browser, and not require middleware authentication or involvement. In an example, the analyst may retrieve the job recommendations while viewing a limited, or public profile for the member. It will be understood that various levels and methods of privacy control may be employed.

The middleware logic may have unrestricted access to the database holding member profiles. In an embodiment, middleware logic does not have unrestricted access to the database, but must use some REST API to pass the member identifier to the recommendation engine. In this case, a simple browser plug-in cannot access the information from the recommendation engine. Instead, requests pass through the middleware logic. The middleware may mimic operation of a member profile and receive job recommendations as if the member had logged on to the recommendation service, with respect to authorization. In embodiments, XML, SOAP protocol, REST API or another method may be used by the browser plug-in to pass the member identifier to the recommendation engine or to the middleware, which may use any method to pass the member identifier to the recommendation engine and receive the recommendations in a viewable format. The protocol used by the middleware logic may depend on implementation details of the recommendation engine and service.

In an embodiment, a Chrome™ browser plug-in may be used. Regardless of protocol, the middleware logic may initiate the recommendation engine service in block 530 by passing the member ID and any required authentication identification to the recommendation engine. The recommendation engine may receive the recommendation request using the same format as if a member had requested the recommendations. The recommendation results may be passed to the middleware in the same format as would be sent to a member requesting the service. In an embodiment, the recommendation engine may be modified to receive a specialized request from the middleware, and perform user authentication/authorization before providing the recommendations. In an example, the middleware logic may also pass information conveying to the recommendation engine how many records to return; where to start (e.g., pagination information); which fields to return; and whether to use cached results. In an embodiment, middleware logic may send member ID, authentication identification, and configuration parameters to the recommendation engine in the query.

After the recommendation service is initiated, the middleware receives the results from the recommendation service and displays the recommendations, in block 540. In an embodiment, the recommendations are displayed adjacent to the member profile on the display, for easy reference. The middleware may provide the information to a module or logic for rendering the information in the GUI. In an embodiment, the middleware may interact directly with a browser, as a plug-in. In another embodiment, the middleware may send raw data to a rendering module for display. The member profile may be displayed adjacent to job recommendations, as described above. In an embodiment, the member profile may appear in a window that may be moved independently from the job recommendations. However, even if rendered in separate windows, rather than in portions of the same application window, the job recommendations are tied to the member profile being displayed. Thus, if the member identifier is changed, the middleware may initiate the recommendation engine for the new member.

The viewable portion of the member profile may be limited. In an embodiment, the member profile may be displayed in a scrollable area of a GUI so that the analyst may view additional information, as necessary, to judge whether a recommended job is relevant. The member profile may appear in a scrollable window in case the analyst desires more information to determine whether the job is relevant to the member.

The analyst may rank or rate the jobs on a relevance scale, in block 550. In an embodiment, a scale of 1-10 may be used. In other embodiments, scales of 1-100, 1-5, 0-3, a simple yes/no, or any other useful scale may be used, as convenient. In an embodiment, more than one qualitative measure may be used for ranking and rating. For instance, a binary relevant vs. non-relevant rating may be used. In an example, an additional second rating on a scale of 1-5, for instance, may be used for judging relevance to skill level, or industry.

Another rating that evaluates scoring for top applicants may be applied. For instance a job recommendation may be of equal relevance to two members, but one may be more qualified or be located more closely to the job (e.g. more years of experience, of geo-location more desirable), etc. Information about whether the selected member has specifically viewed or applied for the job may be an additional factor in judging relevance. In an example, information related to viewed or applied jobs may be displayed with the job information rather than in the member profile. Once labeled or annotated, the analyst's findings may be sent to an algorithm team, in block 560 to help improve the recommendation engine, if desired. In an embodiment, the findings may be stored in a database for later retrieval by an algorithm or customer service team.

In an optional embodiment, relevance information may be correlated and provided to a machine learning model in block 570 to enable retraining of one or more models of the recommendation engine. As described above, the data stored in the evaluation database may be retrieved by the recommendation engine for retraining. The relevance rating or scoring may be used to identify data sets that provide a positive relevance factor. This rating, along with information identifying the member and job information may be used in the retraining. In an embodiment, the member ID may be encrypted or otherwise obfuscated so that a member's privacy may be maintained. In an embodiment, the relevant information contained in the profile may be stored with the relevance rating instead of the actual member ID. For instance, if the recommendation engine uses title, industry, years of experience, skill sets as factors in the model, then the member's coefficients at the time of recommendation may be stored and correlated with the job ID and relevance rating to be used in training. In an embodiment, comments may be standardized to enable specific features of the model to be tuned in retraining. For instance, if industry coefficients are used in the model, then training data may be limited to data that includes an industry comment, for retraining of that feature in the model.

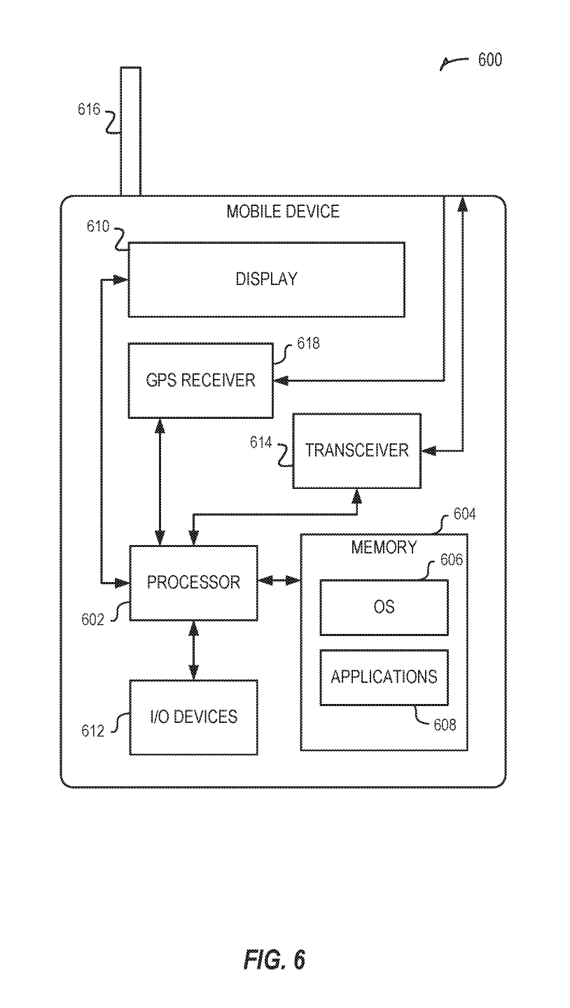

FIG. 6 is a block diagram illustrating the mobile device 600, for interacting with the job recommendation system by a user, according to an example embodiment. The mobile device may correspond to, for example, one or more client machines or application servers. One or more of the components of the job recommendation system, such as, 110 of FIG. 1, may be implemented on or executed by the mobile device 600. The mobile device 600 may include a processor 602. The processor 602 may be any of a variety of different types of commercially available processors 602 suitable for mobile devices 600 (for example, an XScale architecture microprocessor, a microprocessor without interlocked pipeline stages (MIPS) architecture processor, or another type of processor 602). A memory 604, such as a random access memory (RAM), a flash memory, or other type of memory, is typically accessible to the processor 602. The memory 604 may be adapted to store an operating system (OS) 606, as well as application programs 608, such as a mobile location enabled application that may provide LBSs to a user. The processor 602 may be coupled, either directly or via appropriate intermediary hardware, to a display 610 and to one or more input/output (I/O) devices 612, such as a keypad, a touch panel sensor, a microphone, and the like. Similarly, in some embodiments, the processor 602 may be coupled to a transceiver 614 that interfaces with an antenna 616. The transceiver 614 may be configured to both transmit and receive cellular network signals, wireless data signals, or other types of signals via the antenna 616, depending on the nature of the mobile device 600, Further, in some configurations, a GPS receiver 618 may also make use of the antenna 616 to receive GPS signals.

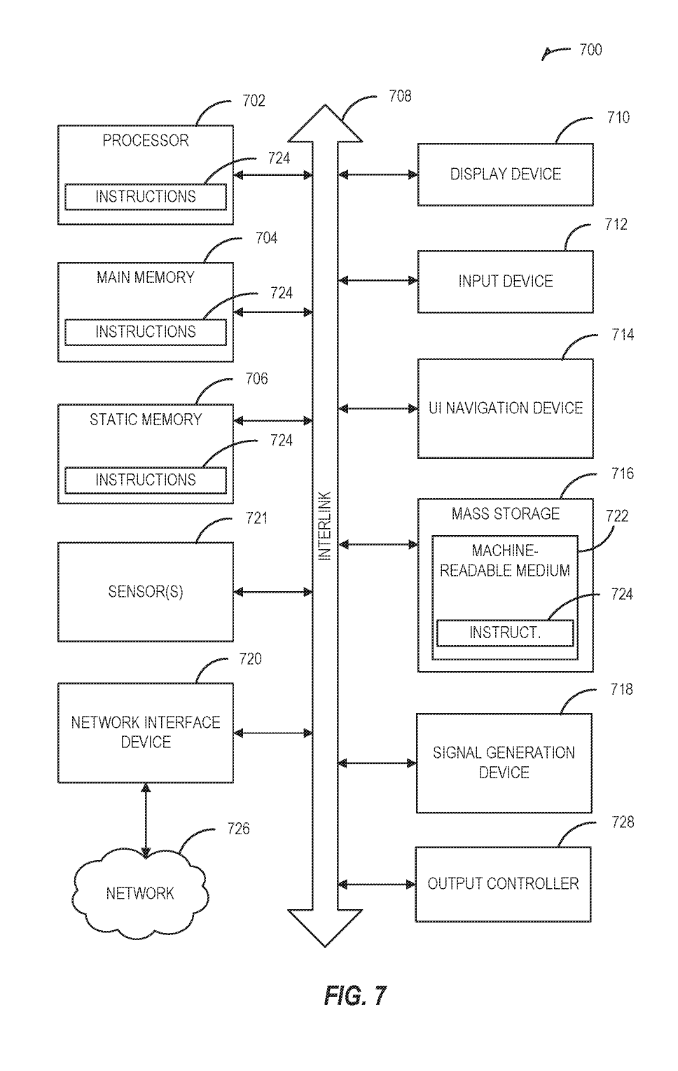

FIG. 7 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### Additional Notes and Examples

Examples may include subject matter such as a method, means for performing acts of the method, at least one machine-readable medium including instructions that, when performed by a machine cause the machine to performs acts of the method, or of an apparatus or system for evaluating the quality of recommendations made for a member subscribed to a recommendation service (e.g., evaluate relevancy of recommendations), according to embodiments and examples described herein.

Example 1 is a computer implemented method for evaluating quality of a recommendation service, comprising: sending a member profile to a computing device for display to a user, responsive to selection of a member by a user; sending a member identifier of the member to middleware logic coupled to a recommendation server; initiating a recommendation request with the member identifier, by the middleware logic to the recommendation server, wherein the recommendation request includes user authentication information; receiving, by the middleware logic, results of the recommendation request, the results comprising at least one item of recommendation for the member; sending the results of the recommendation request to the computing device for display to the user, the display of the results being proximate to the display of the member profile; and providing instructions to the computing device to display an input area that enables the user to indicate relevancy of the at least one item of recommendation to the member.

In Example 2, the subject matter of Example 1 optionally includes responsive to entry of a relevancy rating by the user through the input area, storing the relevancy rating, member identifier and identifier for the at least one item of recommendation in a relevancy database.

In Example 3, the subject matter of Example 2 optionally includes retraining a recommendation model coupled to the recommendation server with relevancy information in the relevancy database.

In Example 4, the subject matter of any one or more of Examples 1-3 optionally include receiving a relevancy rating provided by the user through the input area, wherein the relevancy rating comprises a binary response indicating that the at least one item of recommendation is one of relevant to the member or not relevant to the member.

In Example 5, the subject matter of any one or more of Examples 1-4 optionally include receiving a relevancy rating provided by the user through the input area, wherein the relevancy rating comprises a value within a pre-defined scale for relevance.

In Example 6, the subject matter of any one or more of Examples 1-5 optionally include receiving a relevancy rating provided by the user through the input area, wherein the relevancy rating comprises a numeric relevance rating and a free text comment qualifying the numeric rating, wherein the free text comment corresponds to a coefficient variable used in the recommendation engine.

In Example 7, the subject matter of any one or more of Examples 1-6 optionally include wherein the middleware logic is configured to authenticate the user before initiating the recommendation request to the recommendation server.

Example 8 is at least one computer readable storage medium having instructions stored thereon, the instructions when executed on at least one machine cause the at least one machine to: send a member profile to a computing device for display to a user, responsive to selection of a member by a user; send a member identifier of the member to middleware logic coupled to a recommendation server; initiate a recommendation request with the member identifier, by the middleware logic to the recommendation server, wherein the recommendation request includes user authentication information; receive, by the middleware logic, results of the recommendation request, the results comprising at least one item of recommendation for the member; send the results of the recommendation request to the computing device for display to the user, the display of the results being proximate to the display of the member profile; and provide instructions to the computing device to display an input area that enables the user to indicate relevancy of the at least one item of recommendation to the member.

In Example 9, the subject matter of Example 8 optionally includes instructions to: store the relevancy rating, member identifier and identifier for the at least one item of recommendation in a relevancy database, responsive to entry of a relevancy rating by the user through the input area.

In Example 10, the subject matter of any one or more of Examples 8-9 optionally include instructions to: retrain a recommendation model coupled to the recommendation server with relevancy information in the relevancy database.

In Example 11, the subject matter of any one or more of Examples 8-10 optionally include receiving a relevancy rating provided by the user through the input area, wherein the relevancy rating comprises one of a binary response indicating that the at least one item of recommendation is one of relevant to the member or not relevant to the member, or a value within a pre-defined scale for relevance.

In Example 12, the subject matter of any one or more of Examples 10-11 optionally include receiving a relevancy rating provided by the user through the input area, wherein the relevancy rating comprises a numeric relevance rating and a free text comment qualifying the numeric rating, wherein the free text comment corresponds to a coefficient variable used in the recommendation engine.

Example 13 is a system to evaluate quality of a recommendation service, comprising: a first database including a plurality of member profiles; a second database including a plurality of items for recommendation; a profile server to manage the plurality of member profiles stored in the first database, responsive to a member request to update a member profile associated with the member; a recommendation server comprising a recommendation engine, the recommendation engine configured to recommend an item of the plurality of items to the member, the item to be recommended at least based on a relevance factor; analysis module comprising display logic to display a member profile and at least one recommended item in a display area on a computing device, and labeler logic configured to enable a user to annotate the at least one recommended item with a relevancy rating, the analysis module further configured to store the relevancy rating in a rating database; and middleware logic communicatively coupled to the recommendation server and the analysis module, the middleware configured to receive a member identifier from the analysis module and to initiate a recommendation request to the recommendation server with the received member identifier, the middleware further configured to receive a recommended item for the member and to forward the recommended item to the analysis module.

In Example 14, the subject matter of Example 13 optionally includes wherein the middleware logic is coupled to browser plug-in logic.

In Example 15, the subject matter of any one or more of Examples 13-14 optionally include wherein the display logic causes the member profile to be displayed in a first portion of the display area, and the at least one recommended item to be displayed in a second portion of the display area, wherein the first portion and second portion are proximate to each other.

In Example 16, the subject matter of Example 15 optionally includes wherein the labeler logic causes an input area to be displayed proximate to the second portion of the display area, wherein the input area allows a user to enter the relevancy rating for the at least one recommended item.

In Example 17, the subject matter of Example 16 optionally includes wherein the relevancy rating comprises one of either a binary response indicating that the recommended item is one of relevant or not relevant, or a value within a pre-defined scale for relevance.

In Example 18, the subject matter of any one or more of Examples 16-17 optionally include wherein the relevancy rating comprises a numeric relevance rating and a free text comment qualifying the numeric rating, wherein the free text comment corresponds to a coefficient variable used in the recommendation engine.

In Example 19, the subject matter of any one or more of Examples 13-18 optionally include wherein the middleware logic is further configured to authenticate the user before initiating the recommendation request to the recommendation server.

In Example 20, the subject matter of any one or more of Examples 13-19 optionally include wherein the display logic is configured to display aspects of the member profile based at least on access control criteria associated with privileges of the user.

Example 21 is a system configured to perform operations of any one or more of Examples 1-20.

Example 22 is a method for performing operations of any one or more of Examples 1-20.

Example 23 is a machine readable storage medium including instructions that, when executed by a machine cause the machine to perform the operations of any one or more of Examples 1-20.

Example 24 is a system comprising means for performing the operations of any one or more of Examples 1-20.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones. mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time, Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A computer implemented method for evaluating qua y of a recommendation service, comprising:
sending a member profile to a computing device for display to a user, responsive to selection of a member by a user;
sending a member identifier of the member to middleware logic coupled to a recommendation server;
initiating a recommendation request with the member identifier, by the middleware logic to the recommendation server, wherein the recommendation request includes user authentication information;
receiving, by the middleware logic, results of the recommendation request, the results comprising at least one item of recommendation for the member;
sending the results of the recommendation request to the computing device for display to the user, the display of the results being proximate to the display of the member profile; and
providing instructions to the computing device to display an input area that enables the user to indicate relevancy of the at least one item of recommendation to the member.

2. The computer implemented method as recited in claim 1, further comprising:
responsive to entry of a relevancy rating by the user through the input area, storing the relevancy rating, member identifier and identifier for the at least one item of recommendation in a relevancy database.

3. The computer implemented method as recited in claim 2, further comprising:
retraining a recommendation model coupled to the recommendation server with relevancy information in the relevancy database.

4. The computer implemented method as recited in claim 1, further comprising receiving a relevancy rating provided by the user through the input area, wherein the relevancy rating comprises a binary response indicating that the at least one item of recommendation is one of relevant to the member or not relevant to the member.

5. The computer implemented method as recited in claim 1, further comprising receiving a relevancy rating provided by the user through the input area, wherein the relevancy rating comprises a value within a pre-defined scale for relevance.

6. The computer implemented method as recited in claim 1, further comprising receiving a relevancy rating provided by the user through the input area, wherein the relevancy rating comprises a numeric relevance rating and a free text comment qualifying the numeric rating, wherein the free text comment corresponds to a coefficient variable used in the recommendation engine.

7. The computer implemented method as recited in claim 1, wherein the middleware logic is configured to authenticate the user before initiating the recommendation request to the recommendation server.

8. At least one computer readable storage medium having instructions stored thereon, the instructions when executed on at least one machine cause the at least one machine to:
send a member profile to a computing device for display to a user, responsive to selection of a member by a user;
send a member identifier of the member to middleware logic coupled to a recommendation server:
initiate a recommendation request with the member identifier, by the middleware logic to the recommendation server, wherein the recommendation request includes user authentication information;
receive, by the middleware logic, results of the recommendation request, the results comprising at least one item of recommendation for the member;
send the results of the recommendation request to the computing device for display to the user, the display of the results being proximate to the display of the member profile; and
provide instructions to the computing device to display an input area that enables the user to indicate relevancy of the at least one item of recommendation to the member.

9. The at least one computer readable storage medium as recited in claim 8, further comprising instructions to:
store the relevancy rating, member identifier and identifier for the at least one item of recommendation in a relevancy database, responsive to entry of a relevancy rating by the user through the input area.

10. The at least one computer readable storage medium as recited in claim 8, further comprising instructions to:
retrain a recommendation model coupled to the recommendation server with relevancy information in the relevancy database.

11. The at least one computer readable storage medium as recited in claim 8, further comprising receiving a relevancy rating provided by the user through the input area, wherein the relevancy rating comprises one of a binary response indicating that the at least one item of recommendation is one of relevant to the member or not relevant to the member, or a value within a pre-defined scale for relevance.

12. The at least one computer readable storage medium as recited in claim 10, further comprising receiving a relevancy rating provided by the user through the input area, wherein the relevancy rating comprises a numeric relevance rating and a free text comment qualifying the numeric rating, wherein the free text comment corresponds to a coefficient variable used in the recommendation engine.

13. A system to evaluate quality of a recommendation service, comprising:
a first database including a plurality of member profiles;
a second database including a plurality of items for recommendation;
a profile server to manage the plurality of member profiles stored in the first database, responsive to a member request to update a member profile associated with the member;
a recommendation server comprising a recommendation engine, the recommendation engine configured to recommend an item of the plurality of items to the member, the item to be recommended at least based on a relevance factor;
analysis module comprising display logic to display a member profile and at least one recommended item in a display area on a computing device, and labeler logic configured to enable a user to annotate the at least one recommended item with a relevancy rating, the analysis module further configured to store the relevancy rating in a rating database; and
middleware logic communicatively coupled to the recommendation server and the analysis module, the middleware configured to receive a member identifier from the analysis module and to initiate a recommendation request to the recommendation server with the received member identifier, the middleware further configured to receive a recommended item for the member and to forward the recommended item to the analysis module.

14. The system as recited in claim 13, wherein the middleware logic is coupled to browser plug-in logic.

15. The system as recited in claim 13, wherein the display logic causes the member profile to be displayed in a first portion of the display area, and the at least one recommended item to be displayed in a second portion of the display area, wherein the first portion and second portion are proximate to each other.

16. The system as recited in claim 15, wherein the labeler logic causes an input area to be displayed proximate to the second portion of the display area, wherein the input area allows a user to enter the relevancy rating for the at least one recommended item.

17. The system as recited in claim 16, wherein the relevancy rating comprises one of either a binary response indicating that the recommended item is one of relevant or not relevant, or a value within a pre-defined scale for relevance.

18. The system as recited in claim 16, wherein the relevancy rating comprises a numeric relevance rating and a free text comment qualifying the numeric rating, wherein the free text comment corresponds to a coefficient variable used in the recommendation engine.

19. The system as recited in claim 13, wherein the middleware logic is further configured to authenticate the user before initiating the recommendation request to the recommendation server.

20. The system as recited in claim 13, wherein the display logic is configured to display aspects of the member profile based at least on access control criteria associated with privileges of the user.
